(19) United States
(12) Patent Application Publication
(10) Pub. No.: US 2006/0083380 A1
(43) Pub. Date: Apr. 20, 2006

(54) Receiver

(75) Inventors: Osamu Mino, Kobe-shi (JP); Kazuo Takayama, Kobe-shi (JP)

Correspondence Address: FOGG AND ASSOCIATES, LLC, P.O. BOX 581339, MINNEAPOLIS, MN, 55458-1339, US

(73) Assignee: Fujitsu Ten Limited, Kobe-shi (JP)

(21) Appl. No.: 11/249,665

(22) Filed: Oct. 13, 2005

(30) Foreign Application Priority Data
Oct. 14, 2004 (JP) 2004-300404

(51) Int. Cl. H04H 5/00

(52) U.S. Cl. 381/2; 381/15

(57) ABSTRACT

The invention aims to reduce the amount of circuitry in a receiver for receiving broadcast radio waves transmitted using an IBOC system that allows simultaneous transmissions of an analog broadcast and a digital broadcast with the same content. The amount of circuitry is reduced by making provisions to reproduce only a monaural signal from an analog demodulator. To reduce the unnaturalness that may occur when switching from the digital broadcast to the analog broadcast, a blend processing section mixes the two signals in a smoothly varying ratio during the switching.

### BACKGROUND OF THE INVENTION

1. Field of the Invention

The present invention relates to a receiver for receiving broadcast radio waves that carry an analog stereo broadcast and a digital stereo broadcast, with the same content, in a single broadcast band. More particularly, it relates to a receiver for receiving radio programs broadcast using an IBOC (In-Band On-Channel) system.

2. Description of the Related Art

Systems proposed for providing digital audio broadcasting (DAB) using FM radio frequency bands are expected to provide audio quality comparable to CD quality as well as data services and service areas having higher reliability than those of existing analog FM transmissions. However, during the transition period before the changeover to DAB is completed, broadcasting companies need interim solutions that allow analog and digital signals to be transmitted simultaneously in the same broadcast bands. Such a system is called, for example, in the case of an IBOC system, a hybrid in-band on-channel (HIBOC) system, and is being developed for both FM and AM radio bands.

With an FM HIBOC system, digital signals are transmitted using, for example, two sidebands on both sides of the analog FM host signal in order to prevent conspicuous distortion from being caused in conventional analog FM receivers. A feature of the HIBOC system is that the digital signal is simulcast to broadcast the same content as that being broadcast by the analog signal. Here, if the strength of the digital signal drops, that is, the signal strength becomes weak, the radio reception automatically switches to the analog signal.

The HIBOC system is a transitional system that is only viable until full-digital DAB is implemented; as this requires that digital demodulation as well as analog demodulation be performed at the receiver side, there arises the problem that, if the demodulator circuit is implemented using a digital signal processor (DSP) or the like, the amount of circuitry increases.

Furthermore, switching between analog demodulation and digital demodulation can cause a time difference between the digital and analog broadcasts and also a difference in sound level, and it has been extremely difficult to make adjustments to correct these differences.

### SUMMARY OF THE INVENTION

It is a first object of the present invention to reduce the amount of circuitry in a receiver for receiving broadcast radio waves that carry an analog stereo broadcast and a digital stereo broadcast, with the same content, in a single broadcast band.

It is a second object of the present invention to reduce the unnaturalness that may occur when switching is done from the reproduction of a digital broadcast to the reproduction of an analog broadcast and vice versa.

According to the present invention, there is provided a receiver for receiving broadcast radio waves that carry an analog stereo broadcast and a digital stereo broadcast of the same content in a single broadcast band, comprising: a digital broadcast demodulator for demodulating a stereo signal from the received digital stereo broadcast; an analog broadcast demodulator for demodulating a monaural signal from the received analog stereo broadcast; and a selector for selecting, based on reception conditions, either the stereo signal demodulated by the digital broadcast demodulator or the monaural signal demodulated by the analog broadcast demodulator.

As previously described, when the signal strength becomes weak, the radio reception is automatically switched to the analog signal, but in this case, if the broadcast is received in stereo, it will have increased noise; therefore, the analog broadcast demodulator that is selected when the signal strength becomes weak is configured to produce only monaural signals, which serves to reduce the amount of circuitry in the demodulator circuit.

Preferably, the selector is configured to mix the stereo signal demodulated by the digital broadcast demodulator and the monaural signal demodulated by the analog broadcast demodulator in a smoothly varying mixing ratio during the selection switching process.

This serves to eliminate the unnaturalness that may occur due to an abrupt change in left/right separation when the reception is switched from the digital stereo broadcast to the analog monaural broadcast or vice versa.

Preferably, the analog stereo broadcast and the digital stereo broadcast each carry a timestamp and/or sound level information, and the receiver further comprises a delay element for delaying at least either the stereo signal demodulated by the digital broadcast demodulator or the monaural signal demodulated by the analog broadcast demodulator, and/or a sound level adjuster for adjusting the sound level of at least either one of the stereo signal or the monaural signal, based on the timestamps and/or the sound level information included in the received analog stereo broadcast and the received digital stereo broadcast.

With this configuration, the radio reception can be switched without causing the unnaturalness associated with switching even if there is a time difference or a difference in sound level between the digital and analog broadcasts.

### BRIEF DESCRIPTION OF THE DRAWINGS

FIG. 1 is a block diagram showing the configuration of a receiver according to one embodiment of the present invention;

FIG. 2 is a diagram showing the detailed configuration of a blend processing section 21;

FIG. 3 is a diagram showing one example illustrating how the blend processing section 21 is controlled;

FIG. 4 is a diagram showing another example illustrating how the blend processing section 21 is controlled;

FIG. 5 is a block diagram showing one example of a configuration that can correct a time difference; and

FIG. 6 is a block diagram showing one example of a configuration that can correct a difference in sound level.

### DESCRIPTION OF THE PREFERRED EMBODIMENTS

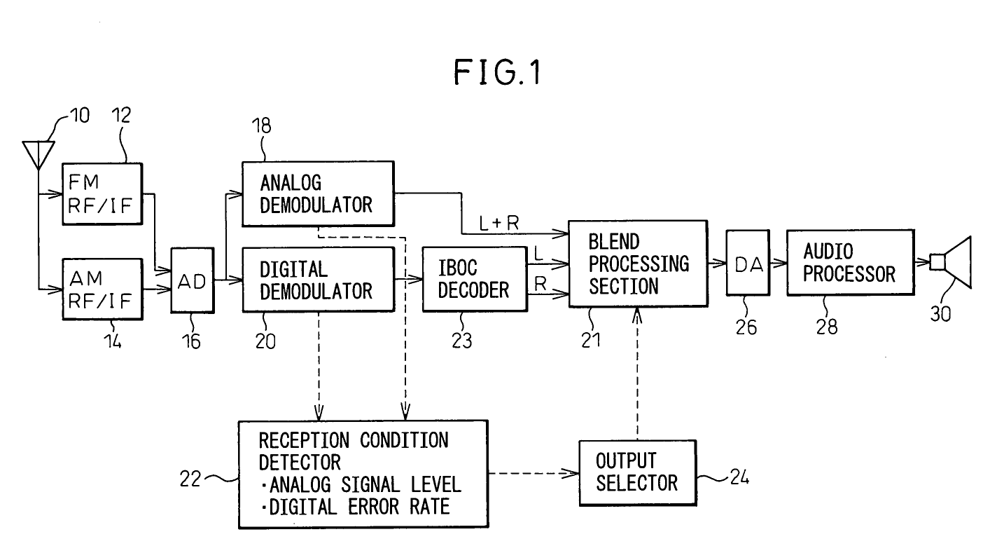

FIG. 1 shows the configuration of a receiver for receiving broadcasts transmitted using an FM/AM HIBOC system according to one embodiment of the present invention. An FM radio wave or an AM radio wave received by an antenna 10 is first converted by a receiving section 12 or 14, respectively, into an IF signal, and then converted by an A/D converter 16 into a digital signal. Of the IF signal converted into the digital signal, an analog broadcast portion is demodulated by an analog demodulator 18 into a monaural signal (L+R). On the other hand, a digital broadcast portion is demodulated by a digital demodulator 20, and PAC (Perceptual Audio Coder) decoding is performed in an IBOC decoder 23 to recover the stereo signal (L, R). A blend processing section 21, under control of an output selector 24, selects the monaural signal output from the analog demodulator 18 or the stereo signal output from the IBOC decoder 23. The selected monaural signal or stereo signal is converted by a DA converter 26 into an analog signal, which is subjected to audio processing in an audio processor 28 to drive a speaker 30.

A reception condition detector 22 detects the reception condition, that is, whether the signal strength is weak or not, based on the CN ratio or the digital error rate or on a combination thereof. When it is determined by the reception condition detector 22 that the signal strength is weak, the output selector 24 causes the blend processing section 21 to switch the selection from the stereo signal reproduced from the digital broadcast to the monaural signal reproduced from the analog broadcast in accordance with the method to be described later. The analog demodulator 18, the digital demodulator 20, the reception condition detector 22, the IBOC decoder 23, the blend processing section 21, and the output selector 24 are implemented, for example, by a DSP (Digital Signal Processor) and a software program that describes the operations of the DSP.

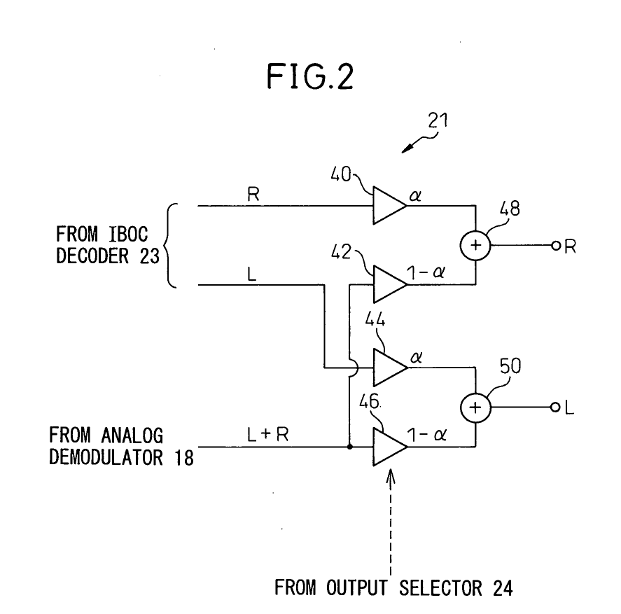

FIG. 2 shows the detailed configuration of the blend processing section 21. The L and R signals from the IBOC decoder 23 are respectively amplified by amplifiers 40 and 44 with an amplification factor a (0≦α≦1), and each amplifier output is supplied to one input of a corresponding one of adders 48 and 50. The L+R signal from the analog demodulator 18 is amplified by amplifiers 42 and 46 with an amplification factor 1−α, and each amplifier output is supplied to the other input of a corresponding one of the adders 48 and 50. The output of the adder 48 and the output of the adder 50 are supplied to the DA converter 26 (FIG. 1) as the R signal and the L signal, respectively. Accordingly, when α is 0, the monaural signal output from the analog demodulator 18 is selected, and when α is 1, the stereo signal output from the digital demodulator 20 is selected; on the other hand, when 0<α<1, the two signals are blended together in a ratio proportional to the value of α.

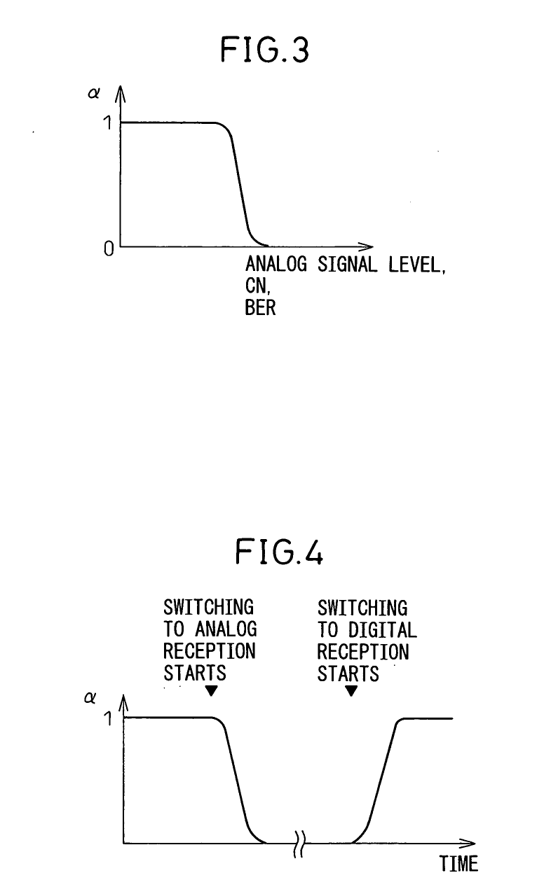

FIG. 3 shows one example illustrating how the blend processing section 21 is controlled in accordance with the value of α. In the illustrated example, the value of α is determined by the analog signal level, CN value, or bit error rate BER or by a combination thereof; for example, when the analog signal level is sufficiently high, the value is set to 1, and when the analog signal level drops below a predetermined value, the value of α decreases smoothly with decreasing analog signal level and reaches 0, as shown by a curve in FIG. 3. When the reception condition recovers, the process is reversed; that is, the value of α increases with increasing signal level and reaches 1.

FIG. 4 shows another example illustrating how the blend processing section 21 is controlled in accordance with the value of α. When it is decided to switch to the analog reception based on the analog signal level, CN value, or bit error rate BER or on a combination thereof, the value of α decreases smoothly with time and reaches 0, as shown by a curve in FIG. 4. If, thereafter, it is decided to switch to the digital reception, the value of α increases smoothly with time and reaches 1, as shown by the curve.

Here, during the switching process where 0<α<1, if the monaural signal (L+R) output from the digital demodulator 20 is used instead of the monaural signal (L+R) output from the analog demodulator 18, the same effect, as described above, can be obtained.

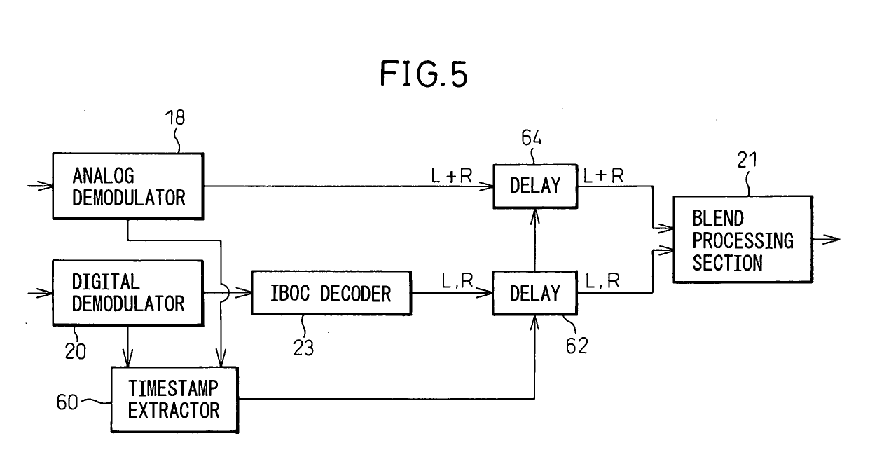

FIG. 5 shows one example of a configuration for correcting the time difference occurring between an analog broadcast and a digital broadcast. A timestamp is inserted in each of the analog and digital broadcasts. The timestamp for the analog broadcast can be inserted, for example, as a 76-kHz L-MSK modulated signal in the modulation spectrum in the same manner as when multiplexing digital data such as a weather forecast, traffic information, etc. in an FM teletext broadcast. The timestamp for the digital broadcast can be inserted, for example, as MPS (Main Program Service) data. A timestamp extractor 60 extracts these timestamps, based on which the amount of delay, of each of delay elements 62 and 64, is controlled so as to eliminate the time difference between the analog and digital broadcasts.

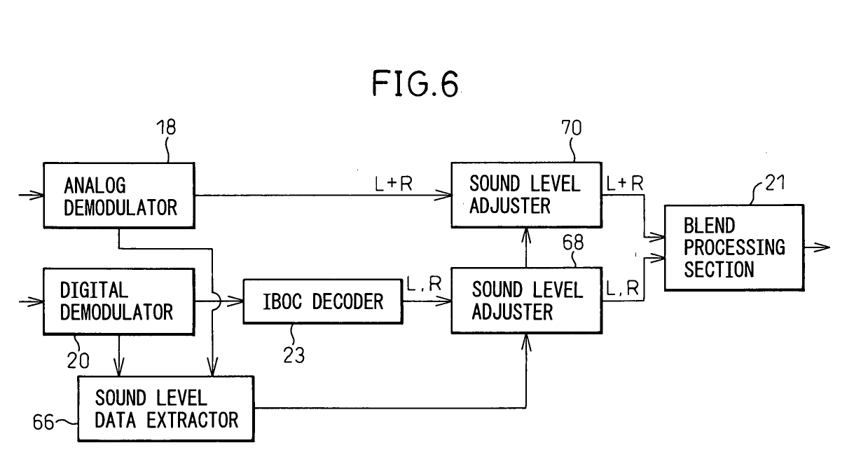

FIG. 6 shows one example of a configuration for correcting the difference in sound level between an analog broadcast and a digital broadcast. Sound level data is inserted in each of the analog and digital broadcasts in the same manner as when inserting the timestamps. A sound level extractor 66 extracts the sound level data, based on which sound level adjusters 68 and 70 are controlled so as to eliminate the difference in sound level between the analog and digital broadcasts. In one method of sound level adjustment, the sound levels of the respective broadcasts are measured at the same timing (for a predetermined length of time) by utilizing the timestamps, and the sound levels are adjusted based on the measurement results.

1. A receiver for receiving broadcast radio waves that carry an analog stereo broadcast and a digital stereo broadcast, with the same content, in a single broadcast band, comprising:
a digital broadcast demodulator for demodulating a stereo signal from the received digital stereo broadcast;
an analog broadcast demodulator for demodulating a monaural signal from the received analog stereo broadcast; and
a selector for selecting, based on reception conditions, one of the stereo signal demodulated by the digital broadcast demodulator and the monaural signal demodulated by the analog broadcast demodulator.

2. A receiver according to claim 1 wherein, during a switching process for selection, the selector mixes the stereo signal demodulated by the digital broadcast demodulator and the monaural signal demodulated by the analog broadcast demodulator in a smoothly varying mixing ratio.

3. A receiver according to claim 2, wherein the mixing ratio varies in accordance with at least one parameter selected from among an analog signal level, a CN value, and a bit error rate.

4. A receiver according to claim 2, wherein the mixing ratio varies smoothly with time.

5. A receiver according to claim 2 wherein, during the switching process for selection, the selector mixes a monaural signal demodulated by the digital broadcast demodulator instead of the monaural signal demodulated by the analog broadcast demodulator.

6. A receiver according to claim 1, wherein the analog stereo broadcast and the digital stereo broadcast each carry a timestamp, and wherein
the receiver further comprises a delay element for delaying at least one of the stereo signal and the monaural signal, based on the timestamps included in the received analog stereo broadcast and the received digital stereo broadcast.

7. A receiver according to claim 1, wherein the analog stereo broadcast and the digital stereo broadcast each carry sound level information, and wherein
the receiver further comprises a sound level adjuster for adjusting the sound level of at least one of the stereo signal and the monaural signal, based on the sound level information included in the received analog stereo broadcast and the received digital stereo broadcast.
